(19) United States
(12) Patent Application Publication
(10) Pub. No.: US 2018/0328275 A1
(43) Pub. Date: Nov. 15, 2018

(54) DEVICE FOR CHANGING A COMPRESSION RATIO OF AN INTERNAL COMBUSTION ENGINE

(71) Applicant: FEV EUROPE GMBH, Aachen (DE)

(72) Inventors: Uwe SCHAFFRATH, Aachen (DE); Christopher MARTEN, Aachen (DE); Peter METHFESSEL, Aachen (DE)

(21) Appl. No.: 15/943,769

(22) Filed: Apr. 3, 2018

(30) Foreign Application Priority Data
Apr. 3, 2017 (DE) 102017107067.2

(51) Int. Cl. F02B 75/04; F16C 7/06; F16C 9/04

(52) U.S. Cl. CPC F02B 75/045; F16C 9/04; F16C 7/06

(57) ABSTRACT

The invention relates to a device for changing a compression ratio of an internal combustion engine.

The device comprises a connecting-rod head (1) with an eccentric bearing (2), an eccentric (3) which is mounted rotatably in the eccentric bearing (2) and which comprises a piston pin bearing (3), a piston pin (5) which is mounted rotatably in the piston pin bearing such that, by means of rotation of the eccentric the position of the piston pin relative to the connecting rod head (1) can be adjusted from a top dead centre to a bottom dead centre and vice versa, and a locking device (8) for locking the eccentric at the top dead centre.

The invention relates to a device for changing a compression ratio of an internal combustion engine.

A device for changing a compression ratio of an internal combustion engine is disclosed in DE102014004987 A1. The device comprises a connecting rod. An eccentric is provided in the connecting-rod head. The eccentric is rotatable to a limited extent by means of two levers.

The device according to the invention for changing a compression ratio of an internal combustion engine comprises a connecting-rod head with an eccentric bearing, an eccentric which is mounted rotatably in the eccentric bearing and which comprises a piston pin bearing, a piston pin which is mounted rotatably in the piston pin bearing such that, by means of rotation of the eccentric, the position of the piston pin relative to the connecting rod head can be adjusted from a top dead centre to a bottom dead centre and vice versa, and an arresting device for locking the eccentric at the top dead centre.

The piston pin is situated at the top dead centre when the eccentric assumes a position in which the piston pin is situated in its uppermost position relative to the connecting-rod head, that is to say is at a maximum distance from the start of a connecting-rod shank, and at the bottom dead centre when the eccentric assumes a position in which the piston pin is situated in its lowermost position relative to the connecting-rod head, that is to say is at a minimum distance from the start of a connecting-rod shank. Here, in relation to the position of the eccentric, deviations of ±20°, preferably of ±10°, particularly preferably of ±5° are still to be regarded as being situated at the top or at the bottom dead centre.

The distance between the two dead centres defines the range in which the compression ratio can be changed. By virtue of the fact that, according to the invention, the piston pin can assume both the top dead centre and the bottom dead centre, the eccentricity of the eccentric can be advantageously utilized, and the compression ratio can be adjusted over a wide range. In relation to solutions in which the eccentric can be adjusted only over a small angular range, the invention permits a similar ± with a smaller eccentricity, which, for example, permits the use of smaller and/or more lightweight components. Furthermore, the invention makes it possible for forces that act on the device during use in an internal combustion engine during a combustion to be absorbed in an effective manner because, at the top dead centre and at the bottom dead centre, a lever formed by the eccentricity between piston pin and eccentric is oriented in the direction of the acting forces. The relatively low loading permits an advantageous design of the device. The locking device permits the locking of the position of the eccentric and the locking of the position of the piston pin and thus of the compression ratio even under the action of external forces.

The device is particularly advantageously designed as a passive system. That is to say, the rotation of the eccentric and thus of the piston pin is effected exclusively by acceleration or inertia forces that act on the device during operation.

The eccentric is rotatable through at least 140°, preferably through at least 160° and particularly preferably through at least 180°. An advantageously large stroke can be realized by means of the wide-angle range. In the case of 180°, a stroke with a length of twice the eccentricity is possible. In a preferred embodiment, the eccentric is rotatable through 360°, that is to say fully rotatable.

A further advantageous embodiment comprises a freewheel, wherein the freewheel is arranged between eccentric and connecting-rod head and blocks a rotation of the eccentric in one of the two possible directions. This advantageously makes it possible for forces that act on the device during use in the internal combustion engine to be utilized for the adjustment of the position of the piston pin to the bottom and/or top dead centre.

A connecting rod according to the invention comprises a device according to the invention. An internal combustion engine according to the invention comprises a connecting rod according to the invention.

The dependent claims described further advantageous embodiments of the invention.

Preferred exemplary embodiments will be discussed in more detail on the basis of the following figures, in which:

FIG. 1 shows a perspective view of a device according to the invention for changing a compression ratio of an internal combustion engine,

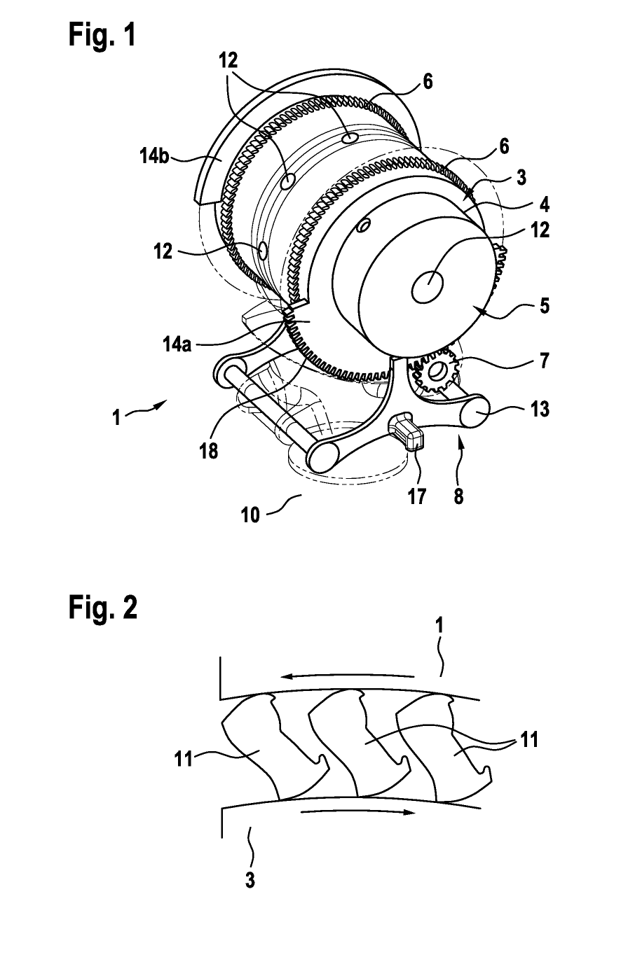

FIG. 2 shows an embodiment of a freewheel,

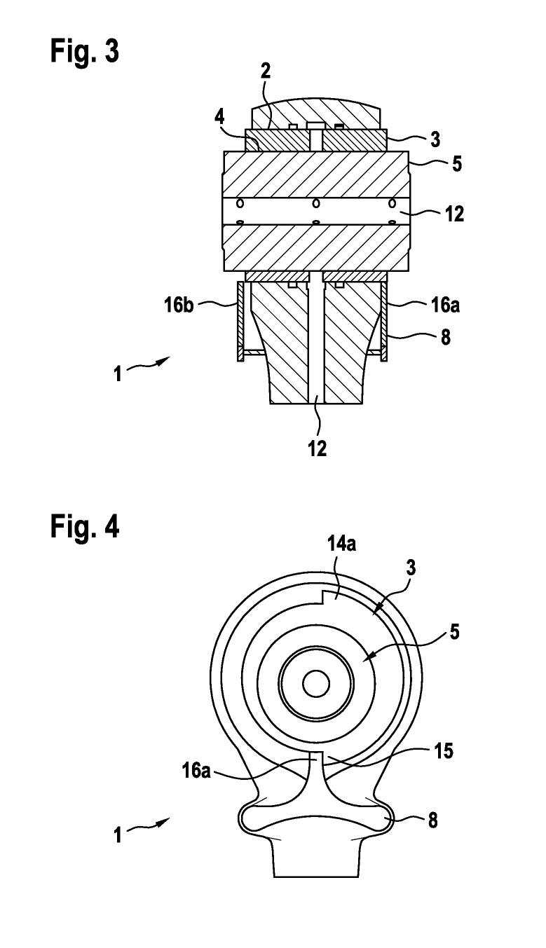

FIG. 3 shows a sectional view of the device,

FIG. 4 shows a side view of the device, and

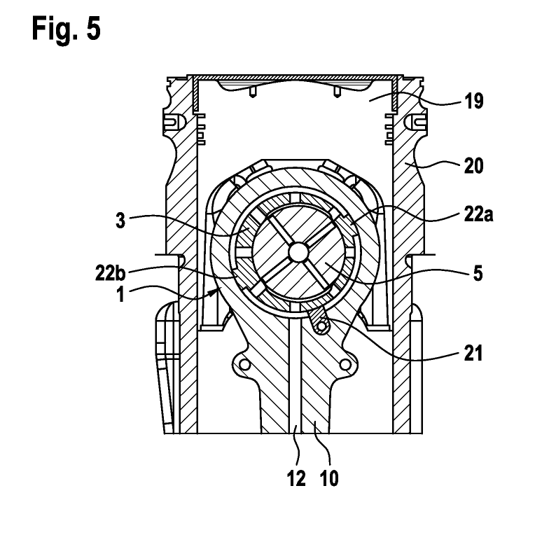

FIG. 5 shows a sectional view of an alternative embodiment of an internal combustion engine according to the invention having a connecting rod with an alternative embodiment of a device according to the invention.

FIGS. 1, 2 and 4 show different views of an embodiment of a device according to the invention for changing the compression ratio of an internal combustion engine.

The device comprises a connecting-rod head 1 with an eccentric bearing 2, an eccentric 3 which is rotatably mounted in the eccentric bearing 2 and which comprises a piston-pin bearing 4, and a piston pin 5 which is rotatably mounted in the piston-pin bearing 4. The device is designed such that, by means of rotation of the eccentric 3, the position of the piston pin 5 relative to the connecting-rod head 1 can be adjusted from a top dead centre to a bottom dead centre and vice versa. Furthermore, the device comprises a locking device 8 for locking the eccentric at the top dead centre. In this exemplary embodiment, the locking device 8 is furthermore designed to lock the eccentric at the bottom dead centre. For lubrication of the device and cooling of the piston, an oil-conducting system 12 with multiple ducts designed for conducting oil is provided.

The eccentric 3 is fully rotatable, that is to say through 360°. The adjustment of the position of the piston pin 5 from the bottom dead centre to the top dead centre or vice versa is realized by means of a rotation of the eccentric through 180°. The rotation of the eccentric is effected, during the use of the device in the internal combustion engine, by forces that act on the device during operation. To permit a targeted adjustment from one dead centre to the other dead centre, the device comprises a freewheel 6. The freewheel 6 is arranged between eccentric 3 and connecting-rod head 1 and blocks a rotation of the eccentric in one of the two possible directions. In this exemplary embodiment, the freewheel 6 comprises a multiplicity of clamping bodies 11 which are turned upright, and jam the connecting-rod head 1 and the eccentric 3 together, in the event of a rotational movement of the eccentric 3 in the blocked direction of rotation, see also FIG. 2. In the event of a rotation in the other direction, the clamping bodies 11 are laid down, with the clamping action being eliminated.

The locking device 8 comprises a slide 13. The slide 13 is movable from a first fixed position into a second fixed position and vice versa. In the first position, the slide 13 blocks a rotation from the top dead centre to the bottom dead centre. In the second position, the slide 13 blocks a rotation from the bottom dead centre to the top dead centre.

In this exemplary embodiment, in each case one control ring 14a, 14b is provided at both ends on the eccentric 3. The control rings 14a, 14b are in this case offset with respect to one another by 180°. Depending on the position of the slide 13, during rotation of the eccentric 3, a stop 15 of the control ring 14a, 14b abuts against one of the projections 16a, 16b, provided at both sides, of the slide 13, whereby the position of the eccentric at the bottom or top dead centre is blocked, see FIG. 4. A rotation in the opposite direction is prevented by the freewheel 6. Movement of the slide 13 into the other position causes the blockage on one side to be eliminated and causes the projection 16a, 16b on the other side of the slide 13 to move into the blockage position. The eccentric 3 can rotate until it assumes the other dead centre, until a further rotation is blocked by a projection 16a, 16b.

The adjustment of the slide 13 into the first or second position is realized in this exemplary embodiment by means of a switch 17 of the slide 13. The switch 17 can for example be actuated mechanically by means of a mechanism provided in the cylinder of the internal combustion engine. The switch 17 or the slide 13 can furthermore also be actuated axially. The implementation is realized for example by means of a slotted guide or electromagnetically.

To dampen the transition in particular from the top dead centre to the bottom dead centre, the device comprises a damping means 7. The damping means 7 is formed in this case as a radial damper in the form of a toothed gear attached to the connecting-rod head 1, which toothed gear engages into a toothed ring 18 formed on the eccentric. The toothed ring determines the angular range in which damping of the rotational movement of the eccentric 3 is to be realized. Here, damping is realized during an adjustment of the eccentric from the top dead centre to the bottom dead centre. This is advantageous because, during the transition to the bottom dead centre during use of the device in an internal combustion engine, high forces act on the device during the combustion via a piston 19 connected to the piston pin 5, which forces would possibly lead to an excessively intense acceleration. Other damping mechanisms are likewise possible. In this exemplary embodiment, toothed ring 18 and control ring 14a are advantageously integrated in one ring in the context of a component reduction.

FIG. 5 shows a part of an internal combustion engine according to the invention with a connecting rod which has the device according to the invention. The internal combustion engine comprises not only the connecting rod, of which the connecting-rod head 1 and the start of a connecting rod shank 10 is illustrated, but also a piston 19, which is connected to the connecting rod, and a cylinder 20, in which the piston 19 is arranged. Furthermore, FIG. 5 shows a further alternative embodiment of a device according to the invention. A switch 21 is provided instead of a slide 8. On the eccentric, two stops 22a, 22b are provided which are offset with respect to one another by 180°. Locking of the rotation of the eccentric at the respective dead centre is effected by virtue of a stop 22a, 22b abutting against the switch 21. A rotation in the opposite direction is prevented by the freewheel 6. Actuation of the switch causes the switch to be moved away, whereby the locking is eliminated and the eccentric 3 can rotate onward.

In a further alternative embodiment, the rotation of the eccentric is restricted to 180°, wherein, at 0°, the eccentric assumes the top dead centre, and at 180°, the eccentric assumes the bottom dead centre. The restriction of the rotation may be realized by means of suitable stops. In this embodiment, the eccentric is rotatable in both directions. The desired direction of rotation is set by means of a switchable freewheel. Depending on the switching of the freewheel, the eccentric can alternate from the top dead centre to the bottom dead centre and vice versa. The rotation is effected by the forces that act on the device during operation.

Further embodiments provide that the rotation of the eccentric is restricted to 160° or to 140°. Even though the full eccentricity is not utilized here, these embodiments nevertheless offer advantages, owing to an advantageous length of the stroke, over conventional solutions in which a rotation of the eccentric is restricted to a much smaller angular range.

The described device according to the invention or the connecting rod according to the invention is not restricted in terms of its use to particular internal combustion engines. For example, the device is suitable for use in internal combustion engines for passenger motor vehicles, for utility vehicles or for use in large engines, such as marine engines.

Use in construction machines or static engines for energy generation is furthermore also conceivable. In this respect, the connecting rod according to the invention is also usable in any reciprocating-piston machine, such as for example compressors or superchargers.

1. Device for changing a compression ratio of an internal combustion engine, comprising a connecting-rod head (1) with an eccentric bearing (2), an eccentric (3) which is mounted rotatably in the eccentric bearing (2) and which comprises a piston pin bearing (4), a piston pin (5) which is mounted rotatably in the piston pin bearing (4) such that, by means of rotation of the eccentric (3), the position of the piston pin (5) relative to the connecting rod head (1) can be adjusted from a top dead centre to a bottom dead centre and vice versa, and a locking device (8) for locking the eccentric (3) at the top dead centre.

2. Device according to claim 1, wherein the eccentric (3) is rotatable through at least 140°, preferably through at least 160° and particularly preferably through at least 180°.

3. Device according to one of the preceding claims, wherein the device is designed such that the rotation of the eccentric (3) occurs passively.

4. Device according to one of the preceding claims, comprising a freewheel (6), wherein the freewheel (6) is arranged between eccentric (3) and connecting-rod head (1) and blocks a rotation of the eccentric (3) in one of the two possible directions.

5. Device according to one of the preceding claims, comprising a damping means (7) which dampens a rotation of the eccentric (3) from the top dead centre to the bottom dead centre at least in one section.

6. Device according to one of the preceding claims, wherein the locking device (8) has a slide (13) which is movable from a first position into a second position and which, in a first position, blocks a rotation of the eccentric (3) from the top dead centre to the bottom dead centre and/or, in the second position, blocks a rotation of the eccentric (3) from the bottom dead centre to the top dead centre.

7. Device according to claim 1, wherein the slide (13) is mechanically actuatable.

8. Connecting rod having a device according to one of claims 1 to 7.

9. Internal combustion engine having a connecting rod according to claim 8.
